(19) United States
(12) Patent Application Publication
(10) Pub. No.: US 2024/0293931 A1
(43) Pub. Date: Sep. 5, 2024

(54) HUMAN-COLLABORATIVE ROBOT ERGONOMIC INTERACTION SYSTEM

(71) Applicant: Intel Corporation, Santa Clara, CA (US)

(72) Inventors: Javier Turek, Beaverton, OR (US); Leobardo Campos Macias, Guadalajara (MX); Rafael De La Guardia Gonzalez, Teuchitlan (MX); Javier Felip Leon, Hillsboro, OR (US); David Gonzalez Aguirre, Portland, OR (US)

(21) Appl. No.: 18/397,441

(22) Filed: Dec. 27, 2023

(51) Int. Cl. B25J 9/16

(52) U.S. Cl. CPC B25J 9/161; B25J 9/1661; B25J 9/1664; B25J 9/1669

(57) ABSTRACT

A system for human-cobot (collaborative robot) ergonomic interaction, including: a communication interface operable to receive sensor data related to human motion; ergonomic assessment processor circuitry operable to evaluate the sensor data to generate a strain score for at least one human joint, wherein the strain score represents a strain level of the at least one human joint based on an integration of motion of the at least one human joint over a period of time; human intent prediction processor circuitry operable to interpret the sensor data to predict an object the human intends to grasp, and to select a destination container for the predicted object; and cobot motion processor circuitry operable to determine a position or orientation for the cobot to place the selected destination container based on the predicted object and the strain score.

### TECHNICAL FIELD

Aspects described herein generally relate to human-collaborative robot (or cobot) interaction and, more particularly, to a system for facilitating human-cobot interaction, taking into consideration human ergonomics and technical capabilities of robots.

### BACKGROUND

Transferring products from storage shelves to consumers involves a variety of tasks. First, objects are retrieved from storage and then sorted, rearranged, and packaged in preparation for shipment. In certain scenarios, such as e-commerce, the sorting, and rearranging processes accommodate a wide variety of products. In particular, sorting and packaging systems should be flexible in handling different objects with different characteristics such as shape, size, texture, color, stiffness, fragility, etc. As a result, humans may be the preferred choice for sorting and packaging such products.

Humans can easily select mixed objects from a tray and place them in a container. However, humans have limitations. Compared to machines, humans tend to be slower in moving objects. They also require breaks, including work shifts and rest periods, and are susceptible to injury and fatigue. The demanding work environment and pace of warehouses and sorting facilities take a toll on humans, with repetitive motions accounting for up to 43% of injuries.

### BRIEF DESCRIPTION OF THE FIGURES

FIG. 1 illustrates a packing station in accordance with aspects of the disclosure.

FIG. 2A illustrates an ergonomic human-cobot interaction system in accordance with aspects of the disclosure.

FIG. 2B illustrates a human intent prediction example in accordance with aspects of the disclosure.

FIG. 3 illustrates a packing station control method in accordance with aspects of the disclosure.

FIG. 4 illustrates a computing device in accordance with aspects of the disclosure.

### DETAILED DESCRIPTION

### I. Overview

The present disclosure is directed to a collaborative robot (cobot)-assisted sorting and packing station 100 operable to reduce ergonomic strain and injuries to human workers. The packing station 100, equipped with at least one cobot 130, increases the efficiency of a human's simultaneous packing of multiple containers 140 and thus increases the overall process efficiency, e.g., in terms of quality and time providing economic benefits. In addition to using product/shipping lists with products/shipping containers listed in sequence, by using predictive algorithms, a human-cobot ergonomic interaction system 200 can predict the human's intent to select an object 112, allowing the cobot 130 to proactively retrieve and position the appropriate destination or shipping container 142 closer to the human. This process is streamlined by the human-cobot ergonomic interaction system 200, which optimizes the placement of the destination container 142 to minimize physical effort and strain for the human. In addition, the cobot 130 is capable of adjusting its operating speed and timing in bringing up the containers 140, further aligns with ergonomic considerations and improves the overall packing and/or unpacking process. Another variation of cobot-assisted packing performed by a human worker to eliminate or reduce strain could be for a cobot to handle or move either the object itself or the container containing the object for packing, so that the human worker can comfortably place the object in the destination or shipping container.

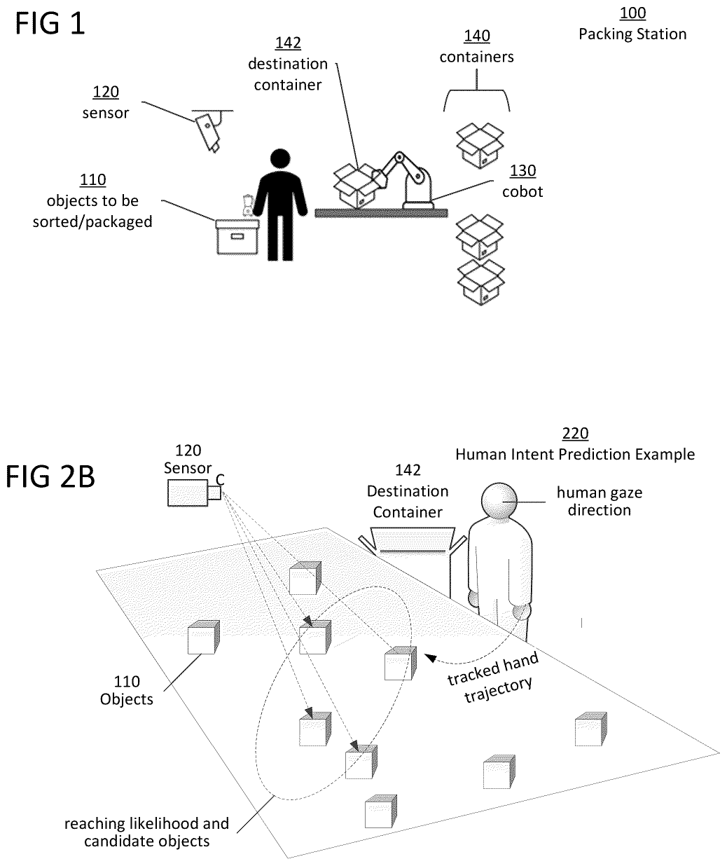

FIG. 1 illustrates a packing station 100 in accordance with aspects of the disclosure.

The packing station 100 comprises objects 110 to be sorted and packaged, sensors 120, a cobot 130 (collaborative robot), and containers 140. A human-cobot ergonomic interaction system 200 controls the operations of the packing station 100, as described below.

The sensors 120 may be cameras and/or other sensors, such as thermal sensors or LIDAR sensors. The sensors 120 detect an object 110 a human intends to grasp.

The cobot 130 can be any type of robot or cobot. For example, the cobot 130 may have multiple arm manipulators, be a rotating plate robot, or even be a specialized robot. The figures and description are for a single cobot 130, but there may be any number of cobots.

In the figure, the leftmost container contains objects 110 to be sorted and packaged. The human reaches out to grasp one of the objects 110. A human-cobot ergonomic interaction system senses the human's movement (e.g., hand motion and gaze direction), predicts which object 110 the human intends to grasp, and proactively selects a destination container 142 for the object 110. The cobot 130 then proactively responds by planning to pick up the destination container 142 and bring it closer to the human. This ensures that object 110 is packed into the destination container 142, thereby reducing human sorting errors when packing multiple containers 140. In addition, the human-cobot ergonomic interaction system determines where to place the destination container 142 taking into account ergonomics to reduce the risk of injury to the human. The human then proceeds to the next object 110. At this point, the human-cobot ergonomic interaction system may dispatch the destination container 142 when the order is completed.

### II. Human-Cobot Ergonomic Interaction System 200

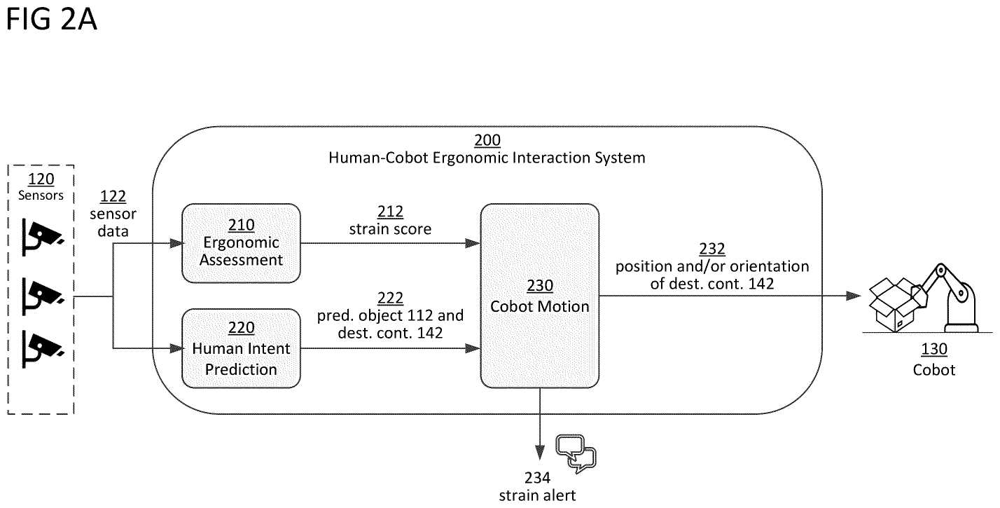

FIG. 2A illustrates a human-cobot ergonomic interaction system 200 in accordance with aspects of the disclosure.

The human-cobot ergonomic interaction system 200 comprises an ergonomic assessment module 210, a human intent prediction module 220, and a cobot motion module 230. A communication interface is operable to receive sensor data 122 related to human motion.

The term “module” is for ease of explanation regarding the functional association between hardware and software components. Alternative terms may include “engine,” “processor circuitry,” or the like.

### A. Ergonomic Assessment Module 210

The ergonomic assessment module 210 is operable to evaluate the sensor data 122 to generate a strain score 212 for at least one human joint, wherein the strain score 212 represents a strain level of the at least one human joint based on an integration of motion of the at least one human joint over a period of time (e.g., full work day, session, two hours . . . ). The strain is a result of the human performing repetitive movements.

The ergonomic assessment module 210 may be operable to generate individual strain scores 212 for a plurality of human joints, each of the strain scores 212 representing a strain level of its respective human joint generated by integrating the motion of the respective human joint over the period of time. The individual strain scores 212 for the plurality of human joints could effectively represent a posture of the human.

Further, the ergonomic assessment module 210 is operable to monitor the progression of the individual strain scores 212. This monitoring of the strain scores 212 may be across all of the joints of the human. In instances where a strain score 212 of a particular joint exceeds a predefined threshold, indicating excessive strain, the cobot motion module 230 may initiate a corrective protocol that mitigates further strain accumulation in the affected joint. This is accomplished by using inverse kinematic simulations of the human's movements. These simulations allow the determination of placement locations and orientations for the destination container 142 being handled by the cobot 130. Such placements are strategically chosen to prevent an escalation of the strain score 212 in the overloaded joint. As a result, the ergonomic assessment module 210, in conjunction with the cobot motion module 230, facilitates interaction between the human and the cobot 130, promotes an equitable distribution of strain across the joints of the human, and thereby enhances ergonomic safety and efficiency in collaborative tasks.

In cases where the ergonomic assessment module 210 is unable to reduce an overall maximum strain level, the strain score 212 may be communicated to the human or the human's supervisor. This data serves as a direct aid to the human, allowing them to adopt alternative tactics for grasping and placing the objects 110 or to modify certain aspects of their physical movements. In addition, this information enables supervisors to implement a rotation system for personnel based on their strain scores 212 rather than rigid time schedules, thereby optimizing task assignments based on ergonomic considerations.

The strain score 212 is generated based on a weighted sum of a cumulative angular displacement during motion of the at least one human joint over the period of time and an average deviation of the motion of the at least one joint from its natural rest position. For example, the strain score 212 of a joint i can be a weighted sum of a cumulative angle qᵢ traversed by the joint motion during a time window of duration n, in addition to an average deviation of the joint from its rest position \hat{q}ᵢ:strain alert

$${s}_{i} ( t , n ) = {\sum }_{t}^{t + n} {w}_{θ} \vert {q}_{l} ( t ) - {q}_{i} ( t + 1 ) \vert + {w}_{l} \vert {q}_{i} ( t ) - {\hat{q}}_{i} \vert , \qquad ( Equation 1 )$$

where w_{θ} is a weight for absolute joint motion, w_{I} is a weight for distance to joint rest position \hat{q}ᵢ, and t is an initial time for strain score generation. This is an example of a strain score and is not intended to be limiting. For example, the strain score 212 may be further based on an exponential decay of the strain score 212, i.e., by adding an exponential decay from a most recent measurement and accumulation data to the initial motion. This decay is taken into account so that a past strain is given less weight than a more recent strain. In addition, the weight of the object 112 being grasped may be considered.

The ergonomic assessment module 210 is further operable to update the strain score 212 after the cobot 130 has placed the selected destination container 142.

### B. Human Intent Prediction Module 220

The human intent prediction module 220 is operable to interpret the sensor data 122 to predict an object 112 that the human intends to grasp and to select a destination container 142 for the predicted object 112 and send the combined result 222 to the cobot motion module 230. In addition, the human intent prediction module 220 is operable to select the destination container 142 for the predicted object 112 from a plurality of candidate destination containers 140.

The objectives of the human intent prediction module 220 are twofold: first, to accurately track human intent during the process of grasping an object 110, and second, to proactively classify the object 110. This proactive classification enables early determination of the destination container 142. By effectively narrowing the range of objects 110 possibly to be grasped, the human intent prediction module 220 improves the accuracy of object classification and early determination. The knowledge of potential destination containers 140 enables the cobot motion module 230 to effectively determine and initiate motion plans. This includes the potential early initiation of container grasping actions, subject to a high level of confidence in the prediction. The methodology for achieving human intent prediction may be implemented using any of a variety of known techniques.

FIG. 2B illustrates an example process wherein a partial trajectory of a human hand, coupled with tracking of the human's gaze direction, is used to predict the final hand position. This prediction of the final hand position enables a focus on object detection and classification efforts in the relevant area, thereby optimizing the prediction process. As a result, this allows the cobot 130 can accurately determine and approach the appropriate destination container 142. The implementation of such prediction and classification processes may be performed, for example, using computer vision facilitated by cameras (sensors 120) and through neural network algorithms.

### C. Cobot Motion Module 230

The cobot motion module 230 is operable to determine a position and/or orientation 232 for the cobot 130 to place the selected destination container 142 based on the predicted object 112 and the strain score 212.

The cobot motion module 230 is further operable to determine the position and/or orientation 232 for the cobot 130 to place the selected destination container 142 while taking into account an operating range of the cobot 130, a speed of the cobot 130, or a potential environmental obstacle. This module 230 prioritizes human ergonomics in its operational planning, ensuring that the movements of the cobot 130 are beneficial and not detrimental to the human.

Upon determining that any of the individual strain scores 212 exceeds a predetermined threshold, the cobot motion module 230 is further operable to adjust the position and/or orientation for the cobot 130 to place the selected destination container 142 to prevent an exacerbation of the strain level of any of the plurality of human joints.

Specifically, the cobot motion module 230 is operable to simulate inverse kinematics modeling human motion to determine the position and/or orientation 232 for the cobot 130 to place the selected destination container 142. The cobot motion module 230 plans movements for the cobot 130 based on a graph-based algorithm with a pre-constructed graph representing possible cobot configurations mapped to Cartesian coordinates. This algorithm is designed to account for potential collisions with environmental obstacles or the human. In addition, the cobot motion module 230 incorporates a dynamic cost function for each graph vertex. Using an extensive database of different human profiles, a specific cost is assigned to each vertex, allowing the system to select paths that optimize human ergonomics.

The planning process takes into account the physical capabilities of the cobot 130, such as the range of joint motions and speed limits. This graph comprises nodes representing cobot configuration that are connected based on the L2 norm. The connections between nodes are established within a predefined neighborhood, determined according to:

$${( \frac{log ( n )}{n} )}^{\frac{1}{d}} , \qquad ( Equation 2 )$$

where n is the number of nodes and d is the degrees of freedom of the cobot 130. This graph is computed offline to produce a set of defined nodes tailored to the desired level of discretization. The flexibility of this algorithm allows it to be adapted to any serial cobot 130 with different degrees of freedom. The algorithm can also be applied to a mobile cobot where, instead of generating joint positions, it generates wheel positions and/or velocities.

The cobot motion module 230 is further operable to issue a strain alert 234 if it is unable to determine a suitable position or orientation for the destination container 142 that does not exacerbate the strain level of the at least one human joint.

### III. Packing Station Control Method 300

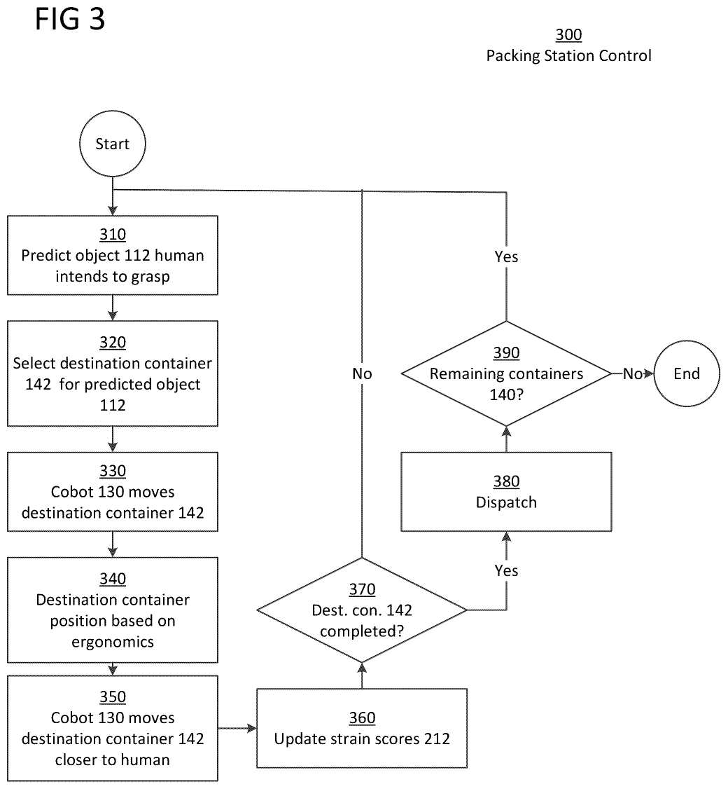

FIG. 3 illustrates a packing station control method 300 for controlling a cobot 130 in a packing station 100 in accordance with aspects of the disclosure. The steps of this method 300 are not necessarily limited to the particular order shown and described.

At step 310, the human intent prediction module 220 predicts which object 112 a human intends to grasp based on the analysis of the human's movements. At step 320, human intent prediction module 220 selects an appropriate destination container 142 for the object 112 predicted to be grasped by the human.

At steps 330-350, the cobot motion module 230 causes the cobot 130 to move the selected destination container 142 to a position determined based on ergonomic principles. At step 360, the ergonomic assessment module 210 uses the sensor data to update the strain score(s) 212 of one or more of the human joints. After that, at step 370, if the destination container 142 is complete, the cobot motion module 230 dispatches the destination container 142 at step 380.

Finally, at step 390, if there are additional containers 140 that require processing, the method 300 may be iteratively applied to these containers 140 remaining.

### IV. Computing Device 400

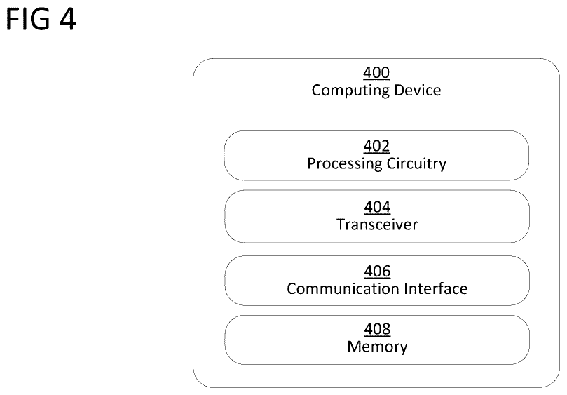

FIG. 4 illustrates a computing device 400 in accordance with aspects of the disclosure.

The computing device 400 may be identified with a central controller and be implemented as any suitable network infrastructure component, which may be implemented as a cloud/edge network server, controller, computing device, etc. The computing device 400 may serve the ergonomic assessment module 210, the human intent prediction module 220, and the cobot motion module 230 in accordance with the various techniques discussed herein. To do so, the computing device 400 may include processor circuitry 402, a transceiver 404, a communication interface 406, and a memory 408. The components shown in FIG. 4 are provided for ease of explanation, and the computing device 400 may implement additional, fewer, or alternative components than those shown in FIG. 4.

The processor circuitry 402 may be operable as any suitable number and/or type of computer processor that may function to control the computing device 400. The processor circuitry 402 may be identified with one or more processors (or suitable portions thereof) implemented by the computing device 400. The processor circuitry 402 may be identified with one or more processors such as a host processor, a digital signal processor, one or more microprocessors, graphics processors, baseband processors, microcontrollers, an application-specific integrated circuit (ASIC), a portion (or the entirety of) a field-programmable gate array (FPGA), etc.

In any case, the processor circuitry 402 may be operable to execute instructions to perform arithmetic, logic, and/or input/output (I/O) operations and/or to control the operation of one or more components of the computing device 400 to perform various functions as described herein. The processor circuitry 402 may include one or more microprocessor cores, memory registers, buffers, clocks, etc. It may generate electronic control signals associated with the components of the computing device 400 to control and/or modify the operation of those components. The processor circuitry 402 may communicate with and/or control functions associated with the transceiver 404, the communication interface 406, and/or the memory 408. The processor circuitry 402 may additionally perform various operations to control the communications, communications scheduling, and/or operation of other network infrastructure components communicatively coupled to the computing device 400.

The transceiver 404 may be implemented as any suitable number and/or type of components operable to transmit and/or receive data packets and/or wireless signals in accordance with any suitable number and/or type of communication protocols. The transceiver 404 may include any suitable type of components to facilitate this functionality, including components associated with known transceiver, transmitter, and/or receiver operations, configurations, and implementations. Although shown as a transceiver in FIG. 4, the transceiver 404 may include any suitable number of transmitters, receivers, or combinations thereof, which may be integrated into a single transceiver or as multiple transceivers or transceiver modules. The transceiver 404 may include components typically identified with a radio frequency (RF) front end and include, for example, antennas, ports, power amplifiers (PAS), RF filters, mixers, local oscillators (LOs), low noise amplifiers (LNAs), up-converters, down-converters, channel tuners, etc.

The communication interface 406 may be implemented as any suitable number and/or type of components operable to facilitate the transceiver 404 to receive and/or transmit data and/or signals in accordance with one or more communication protocols, as discussed herein. The communication interface 406 may be implemented as any suitable number and/or type of components operable to interface with the transceiver 404, such as analog-to-digital converters (ADCs), digital-to-analog converters, intermediate frequency (IF) amplifiers and/or filters, modulators, demodulators, baseband processors, and the like. The communication interface 406 may thus operate in conjunction with the transceiver 404 and form part of an overall communication circuitry implemented by the computing device 400, which may be implemented via the computing device 400 to transmit commands and/or control signals to perform any of the functions described herein.

The memory 408 is operable to store data and/or instructions such that when the instructions are executed by the processor circuitry 402, they cause the computing device 400 to perform various functions as described herein. The memory 408 may be implemented as any known volatile and/or non-volatile memory, including, for example, read-only memory (ROM), random access memory (RAM), flash memory, a magnetic storage medium, an optical disk, erasable programmable read-only memory (EPROM), programmable read-only memory (PROM), etc. The memory 408 may be non-removable, removable, or a combination of the two. The memory 408 may be implemented as a non-transitory computer-readable medium storing one or more executable instructions such as logic, algorithms, code, etc.

As further discussed below, the instructions, logic, code, etc., stored in the memory 408 are represented by the various modules/engines as shown in FIG. 4. Alternatively, when implemented via hardware, the modules/engines shown in FIG. 4 associated with the memory 408 may include instructions and/or code to facilitate control and/or monitoring the operation of such hardware components. In other words, the modules/engines shown in FIG. 4 are provided to facilitate an explanation of the functional association between hardware and software components. Thus, the processor circuitry 402 may execute the instructions stored in these respective modules/engines in conjunction with one or more hardware components to perform the various functions discussed herein.

Various aspects described herein may utilize one or more machine learning models for ergonomic assessment 210, human intent prediction 220, and cobot motion control 230. The term “model,” as used herein, may be understood to mean any type of algorithm that provides output data from input data (e.g., any type of algorithm that generates or calculates output data from input data). A machine learning model can be executed by a computing system to progressively improve the performance of a particular task. In some aspects, the parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be tuned during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, each of the machine learning models may utilize supervised learning, semi-supervised learning, unsupervised learning, or reinforcement learning techniques.

In supervised learning, the model may be built using a training set of data that includes both the inputs and the corresponding desired outputs (illustratively, each input may be associated with a desired or expected output for that input). Each training instance may include one or more inputs and a desired output. Training may involve iterating through training instances and using an objective function to teach the model to predict the output for new inputs (illustratively, for inputs not included in the training set). In semi-supervised learning, a portion of the inputs in the training set may lack corresponding desired outputs (e.g., one or more inputs may not be associated with any desired or expected output).

In unsupervised learning, the model may be built from a training set of data that includes only inputs and no desired outputs. The unsupervised model may be used to find structure in the data (e.g., grouping or clustering of data points), for example, by discovering patterns in the data. Techniques that may be implemented in an unsupervised learning model may, for example, self-organizing maps, nearest-neighbor mapping, k-means clustering, and singular value decomposition.

Reinforcement learning models may include positive or negative feedback to improve accuracy. A reinforcement learning model may attempt to maximize one or more goals/rewards. Techniques that may be implemented in a reinforcement learning model may include, for example, Q-learning, temporal difference (TD), and deep adversarial networks.

Various aspects described herein may utilize one or more classification models. In a classification model, outputs may be restricted to a limited set of values (e.g., one or more classes). The classification model may output a class for an input set of one or more input values. An input set may include sensor data, such as image data, radar data, LIDAR (light detection and ranging) data, and the like. A classification model as described herein may, for example, classify certain driving conditions and/or environmental conditions, such as weather conditions, road conditions, and the like. References herein to classification models may contemplate a model that implements, for example, one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (e.g., starting from or using an input set of one or more values). References herein to regression models may contemplate a model that implements, for example, one or more of the following techniques (or other suitable techniques): linear regression, decision trees, random forests, or neural networks.

A machine learning model described herein may be or include a neural network. The neural network may be any type of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network can have any number of layers. The training of the neural network (e.g., the adaption of the layers of the neural network) may use or be based on any kind of training principle, such as backpropagation (e.g., using the backpropagation algorithm).

The techniques of this disclosure may also be described in the following examples.

Example 1. A system for human-cobot (collaborative robot) ergonomic interaction, comprising: a communication interface operable to receive sensor data related to human motion; ergonomic assessment processor circuitry operable to evaluate the sensor data to generate a strain score for at least one human joint, wherein the strain score represents a strain level of the at least one human joint based on an integration of motion of the at least one human joint over a period of time; human intent prediction processor circuitry operable to interpret the sensor data to predict an object the human intends to grasp, and to select a destination container for the predicted object; and cobot motion processor circuitry operable to determine a position or orientation for the cobot to place the selected destination container based on the predicted object and the strain score.

Example 2. The system of example 1, wherein the ergonomic assessment processor circuitry is further operable to generate individual strain scores for a plurality of human joints, wherein each of the strain scores represents a strain level of its respective human joint, generated by integrating motion of the respective human joint over the period of time.

Example 3. The system of example 2, wherein the ergonomic assessment processor circuitry is further operable to monitor progressions of the individual strain scores.

Example 4. The system of example 3, wherein upon determining that any of the individual strain scores exceeds a predetermined threshold, the cobot motion processor circuitry is further operable to adjust the position or orientation for the cobot to place the selected destination container to prevent exacerbation of the strain level of any of the plurality of human joints.

Example 5. The system of any of examples 1-4, wherein the strain score is generated based on a weighted sum of a cumulative angular displacement during the motion of the at least one human joint over the period of time and an average deviation of the motion of the at least one joint from its natural rest position.

Example 6. The system of any of examples 1-5, wherein the strain score is further based on an exponential decay of the strain score.

Example 7. The system of any of examples 1-6, wherein the cobot motion processor circuitry is further operable to simulate inverse kinematics modeling the human motion to determine the position or orientation for the cobot to place the selected destination container.

Example 8. The system of any of examples 1-7, wherein the ergonomic assessment processor circuitry is further operable to update the strain score after the cobot has placed the selected destination container.

Example 9. The system of any of examples 1-8, wherein the human intent prediction processor circuitry is further operable to select the destination container for the predicted object from a plurality of candidate destination containers.

Example 10. The system of any of examples 1-9, wherein the cobot motion processor circuitry is further operable to issue a strain alert if it is unable to determine a suitable position or orientation for the destination container that does not exacerbate the strain level of the at least one human joint.

Example 11. The system of any of examples 1-10, wherein the cobot motion processor circuitry is further operable to use a graph-based algorithm to determine the position or orientation for the cobot to place the selected destination container.

Example 12. The system of example 11, wherein the cobot motion processor circuitry is further operable to determine the position or orientation for the cobot to place the selected destination container while taking into account an operating range of the cobot, a speed of the cobot, or a potential environmental obstacle.

Example 13. A component of a system for human-cobot (collaborative robot) ergonomic interaction, comprising: processor circuitry; and a non-transitory computer-readable storage medium including instructions that, when executed by the processor circuitry, cause the processor circuitry to: receive sensor data related to human motion; evaluate the sensor data to generate a strain score for at least one human joint, wherein the strain score represents a strain level of the at least one human joint based on an integration of motion of the at least one human joint over a period of time; interpret the sensor data to predict an object the human intends to grasp, and to select a destination container for the predicted object; and determine a position or orientation for the cobot to place the selected destination container based on the predicted object and the strain score.

Example 14. The component of example 13, wherein the instructions further cause the processor circuitry to: generate individual strain scores for a plurality of human joints, wherein each of the strain scores represents a strain level of its respective human joint, generated by integrating motion of the respective human joint over the period of time.

Example 15. The component of example 14, wherein the instructions further cause the processor circuitry to: monitor progressions of the individual strain scores.

Example 16. The component of example 15, wherein upon determining that any of the individual strain scores exceeds a predetermined threshold, the instructions further cause the processor circuitry to: adjust the position or orientation for the cobot to place the selected destination container to prevent exacerbation of the strain level of any of the plurality of human joints.

Example 17. The component of any of examples 13-16, wherein the strain score is generated based on a weighted sum of a cumulative angular displacement during the motion of the at least one human joint over the period of time and an average deviation of the motion of the at least one joint from its natural rest position.

Example 18. The component of any of examples 13-17, wherein the strain score is further based on an exponential decay of the strain score.

Example 19. The component of any of examples 13-18, wherein the instructions further cause the processor circuitry to: simulate inverse kinematics modeling the human motion to determine the position or orientation for the cobot to place the selected destination container.

Example 20. The component of any of examples 13-19, wherein the instructions further cause the processor circuitry to: update the strain score after the cobot has placed the selected destination container.

Example 21. A system for human-cobot (collaborative robot) ergonomic interaction, comprising: a communication interface for receiving receive sensor data related to human motion; ergonomic assessment processor means for evaluating the sensor data to generate a strain score for at least one human joint, wherein the strain score represents a strain level of the at least one human joint based on an integration of motion of the at least one human joint over a period of time; human intent prediction processor means for interpreting the sensor data to predict an object the human intends to grasp, and for selecting a destination container for the predicted object; and cobot motion processor means for determining a position or orientation for the cobot to place the selected destination container based on the predicted object and the strain score.

Example 22. The system of example 21, wherein the ergonomic assessment processor means is further for generating individual strain scores for a plurality of human joints, wherein each of the strain scores represents a strain level of its respective human joint, generated by integrating motion of the respective human joint over the period of time.

Example 23. The system of example 22, wherein the ergonomic assessment processor means is further for monitoring progressions of the individual strain scores.

Example 24. The system of example 23, wherein upon determining that any of the individual strain scores exceeds a predetermined threshold, the cobot motion processor means is further for adjusting the position or orientation for the cobot to place the selected destination container to prevent exacerbation of the strain level of any of the plurality of human joints.

Example 25. The system of any of examples 21-24, wherein the strain score is generated based on a weighted sum of a cumulative angular displacement during the motion of the at least one human joint over the period of time and an average deviation of the motion of the at least one joint from its natural rest position.

Example 26. The system of any of examples 21-25, wherein the strain score is further based on an exponential decay of the strain score.

Example 27. The system of any of examples 21-26, wherein the cobot motion processor means is further for simulating inverse kinematics modeling the human motion to determine the position or orientation for the cobot to place the selected destination container.

Example 28. The system of any of examples 21-27, wherein the ergonomic assessment processor means is further for updating the strain score after the cobot has placed the selected destination container.

Example 29. The system of any of examples 21-28, wherein the human intent prediction processor means is further for selecting the destination container for the predicted object from a plurality of candidate destination containers.

Example 30. The system of any of examples 21-29, wherein the cobot motion processor means is further for issuing a strain alert if it is unable to determine a suitable position or orientation for the destination container that does not exacerbate the strain level of the at least one human joint.

Example 31. The system of any of examples 21-30, wherein the cobot motion processor means is further for using a graph-based algorithm to determine the position or orientation for the cobot to place the selected destination container.

Example 32. The system of example 31, wherein the cobot motion processor means is further for determining the position or orientation for the cobot to place the selected destination container while taking into account an operating range of the cobot, a speed of the cobot, or a potential environmental obstacle.

While the foregoing has been described in conjunction with the exemplary aspect, it is understood that the term “exemplary” is merely meant as an example rather than the best or optimal. Accordingly, the disclosure is intended to cover alternatives, modifications, and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A system for human-cobot (collaborative robot) ergonomic interaction, comprising:
a communication interface operable to receive sensor data related to human motion;
ergonomic assessment processor circuitry operable to evaluate the sensor data to generate a strain score for at least one human joint, wherein the strain score represents a strain level of the at least one human joint based on an integration of motion of the at least one human joint over a period of time;
human intent prediction processor circuitry operable to interpret the sensor data to predict an object the human intends to grasp, and to select a destination container for the predicted object; and
cobot motion processor circuitry operable to determine a position or orientation for the cobot to place the selected destination container based on the predicted object and the strain score.

2. The system of claim 1, wherein the ergonomic assessment processor circuitry is further operable to generate individual strain scores for a plurality of human joints, wherein each of the strain scores represents a strain level of its respective human joint, generated by integrating motion of the respective human joint over the period of time.

3. The system of claim 2, wherein the ergonomic assessment processor circuitry is further operable to monitor progressions of the individual strain scores.

4. The system of claim 3, wherein upon determining that any of the individual strain scores exceeds a predetermined threshold, the cobot motion processor circuitry is further operable to adjust the position or orientation for the cobot to place the selected destination container to prevent exacerbation of the strain level of any of the plurality of human joints.

5. The system of claim 1, wherein the strain score is generated based on a weighted sum of a cumulative angular displacement during the motion of the at least one human joint over the period of time and an average deviation of the motion of the at least one joint from its natural rest position.

6. The system of claim 1, wherein the strain score is further based on an exponential decay of the strain score.

7. The system of claim 1, wherein the cobot motion processor circuitry is further operable to simulate inverse kinematics modeling the human motion to determine the position or orientation for the cobot to place the selected destination container.

8. The system of claim 1, wherein the ergonomic assessment processor circuitry is further operable to update the strain score after the cobot has placed the selected destination container.

9. The system of claim 1, wherein the human intent prediction processor circuitry is further operable to select the destination container for the predicted object from a plurality of candidate destination containers.

10. The system of claim 1, wherein the cobot motion processor circuitry is further operable to issue a strain alert if it is unable to determine a suitable position or orientation for the destination container that does not exacerbate the strain level of the at least one human joint.

11. The system of claim 1, wherein the cobot motion processor circuitry is further operable to use a graph-based algorithm to determine the position or orientation for the cobot to place the selected destination container.

12. The system of claim 11, wherein the cobot motion processor circuitry is further operable to determine the position or orientation for the cobot to place the selected destination container while taking into account an operating range of the cobot, a speed of the cobot, or a potential environmental obstacle.

13. A component of a system for human-cobot (collaborative robot) ergonomic interaction, comprising:
processor circuitry; and
a non-transitory computer-readable storage medium including instructions that, when executed by the processor circuitry, cause the processor circuitry to:
receive sensor data related to human motion;
evaluate the sensor data to generate a strain score for at least one human joint, wherein the strain score represents a strain level of the at least one human joint based on an integration of motion of the at least one human joint over a period of time;
interpret the sensor data to predict an object the human intends to grasp, and to select a destination container for the predicted object; and
determine a position or orientation for the cobot to place the selected destination container based on the predicted object and the strain score.

14. The component of claim 13, wherein the instructions further cause the processor circuitry to:
generate individual strain scores for a plurality of human joints, wherein each of the strain scores represents a strain level of its respective human joint, generated by integrating motion of the respective human joint over the period of time.

15. The component of claim 14, wherein the instructions further cause the processor circuitry to:
monitor progressions of the individual strain scores.

16. The component of claim 15, wherein upon determining that any of the individual strain scores exceeds a predetermined threshold, the instructions further cause the processor circuitry to:
adjust the position or orientation for the cobot to place the selected destination container to prevent exacerbation of the strain level of any of the plurality of human joints.

17. The component of claim 13, wherein the strain score is generated based on a weighted sum of a cumulative angular displacement during the motion of the at least one human joint over the period of time and an average deviation of the motion of the at least one joint from its natural rest position.

18. The component of claim 13, wherein the strain score is further based on an exponential decay of the strain score.

19. The component of claim 13, wherein the instructions further cause the processor circuitry to:
simulate inverse kinematics modeling the human motion to determine the position or orientation for the cobot to place the selected destination container.

20. The component of claim 13, wherein the instructions further cause the processor circuitry to:
update the strain score after the cobot has placed the selected destination container.
